(19) United States
(12) Patent Application Publication
(10) Pub. No.: US 2024/0155509 A1
(43) Pub. Date: May 9, 2024

(54) TRANSMISSION AND RECEPTION OF POWER REPORTS

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/493,681

(22) Filed: Oct. 24, 2023

Related U.S. Application Data
(60) Provisional application No. 63/423,334, filed on Nov. 7, 2022.

(51) Int. Cl. H04W 52/36

(52) U.S. Cl. CPC H04W 52/365; H04W 72/232

(57) ABSTRACT

Methods and apparatuses for transmission and reception of power reports. A method of operating a user equipment (UE) includes transmitting first information indicating a first power class associated with a first maximum output power on a first carrier; determining a delta power class associated with the first power class on the first carrier; and transmitting second information indicating the delta power class in a power headroom report. The delta power class is a power offset for the first power class.

### CROSS-REFERENCE TO RELATED AND CLAIM OF PRIORITY

The present application claims priority under 35 U.S.C. § 119(e) to U.S. Provisional Patent Application 63/423,334 filed on Nov. 7, 2022, which is hereby incorporated by reference in its entirety.

### TECHNICAL FIELD

The present disclosure relates generally to wireless communication systems and, more specifically, the present disclosure relates to methods and apparatus for transmission and reception of power reports.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to transmission and reception of power reports.

In an embodiment, a user equipment (UE) is provided. The UE includes a transceiver configured to transmit first information indicating a first power class associated with a first maximum output power on a first carrier. The UE further includes a processor operably coupled to the transceiver. The processor is configured to determine a delta power class associated with the first power class on the first carrier. The delta power class is a power offset for the first power class. The transceiver is further configured to transmit second information indicating the delta power class in a power headroom report.

In another embodiment, a base station (BS) is provided. The BS includes a transceiver configured to receive first information indicating a first power class associated with a first maximum output power on a first carrier and second information, in a power headroom report, indicating a delta power class. The delta power class is a power offset for the first power class. The BS further includes a processor operably coupled to the transceiver. The processor is configured to determine the delta power class associated with the first power class on the first carrier.

In yet another embodiment, a method is provided. The method includes transmitting first information indicating a first power class associated with a first maximum output power on a first carrier; determining a delta power class associated with the first power class on the first carrier; and transmitting second information indicating the delta power class in a power headroom report. The delta power class is a power offset for the first power class.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates a flowchart of an example procedure for a UE to determine a transmit power during an evaluation period according to embodiments of the present disclosure;

FIG. 6 illustrates a flowchart of another example procedure for a UE to determine a transmit power during an evaluation period according to embodiments of the present disclosure;

FIG. 7 illustrates a flowchart of an example procedure for a UE to report an available power over a time period for uplink (UL), Carrier aggregation (CA), or dual connectivity (DC) operation with a first and second component carrier (CC) according to embodiments of the present disclosure;

FIG. 8 illustrates a flowchart of an example procedure for a UE to report an available power for transmission over a time period for a subband of a downlink (DL) bandwidth part (BWP) according to embodiments of the present disclosure;

FIG. 9 illustrates an example of a timeline for a UE to estimate an average power and support a corresponding power level according to embodiments of the present disclosure;

FIG. 10 illustrates a flowchart of an example procedure for a UE to determine an energy report associated with an indicated transmission time interval based on an indication by a higher layer or by a downlink control information (DCI) format according to embodiments of the present disclosure;

FIG. 11 illustrates a flowchart of an example procedure for a UE to determine an energy report associated with a transmission time interval determined by the UE according to embodiments of the present disclosure; and

FIG. 12 illustrates a flowchart of an example procedure for a UE to provide an energy report based on a triggering by a gNB according to embodiments of the present disclosure.

### DETAILED DESCRIPTION

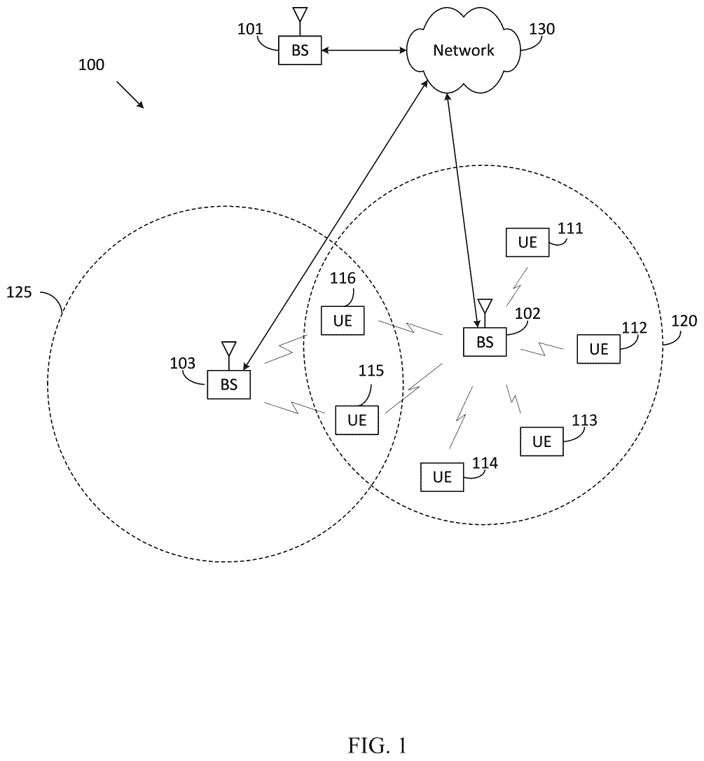

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.2.0, “NR; Physical channels and modulation”; [2] 3GPP TS 38.212 v17.2.0, “NR; Multiplexing and channel coding”; [3] 3GPP TS 38.213 v17.2.0, “NR; Physical layer procedures for control”; [4] 3GPP TS 38.214 v17.2.0, “NR; Physical layer procedures for data”; [5] 3GPP TS 38.321 v17.1.0, “NR; Medium Access Control (MAC) Protocol Specification”; [6] 3GPP TS 38.331 v17.1.0, “NR; Radio Resource Control (RRC) Protocol Specification”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for transmitting power reports. In certain embodiments, one or more of the BSs 101-103 include circuitry, programing, or a combination thereof for reception of power reports.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

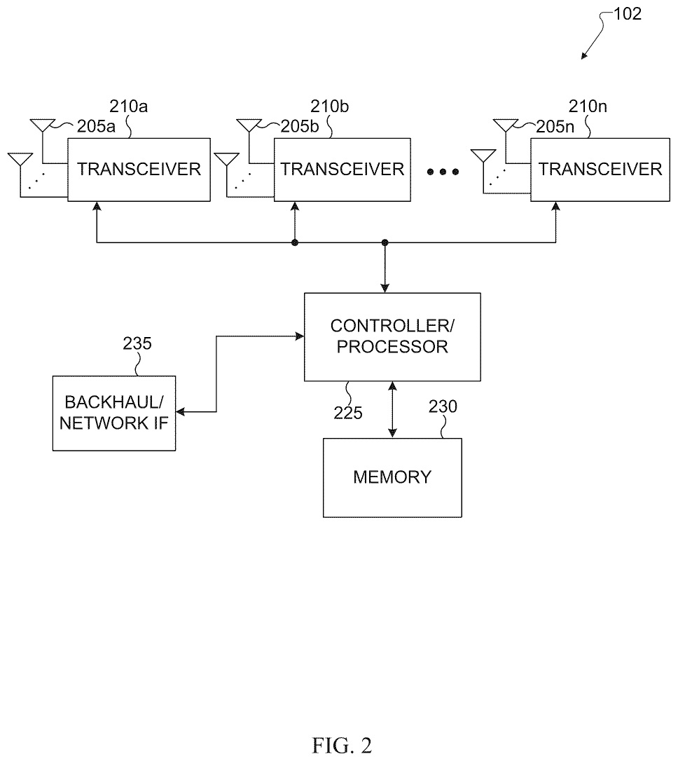

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting transmission of power reports. Any of a wide variety of other functions could be supported in the gNB 102 by the controller/processor 225.

The controller/processor 225 is also capable of executing programs and other processes resident in the memory 230, such as processes for reception of power reports. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

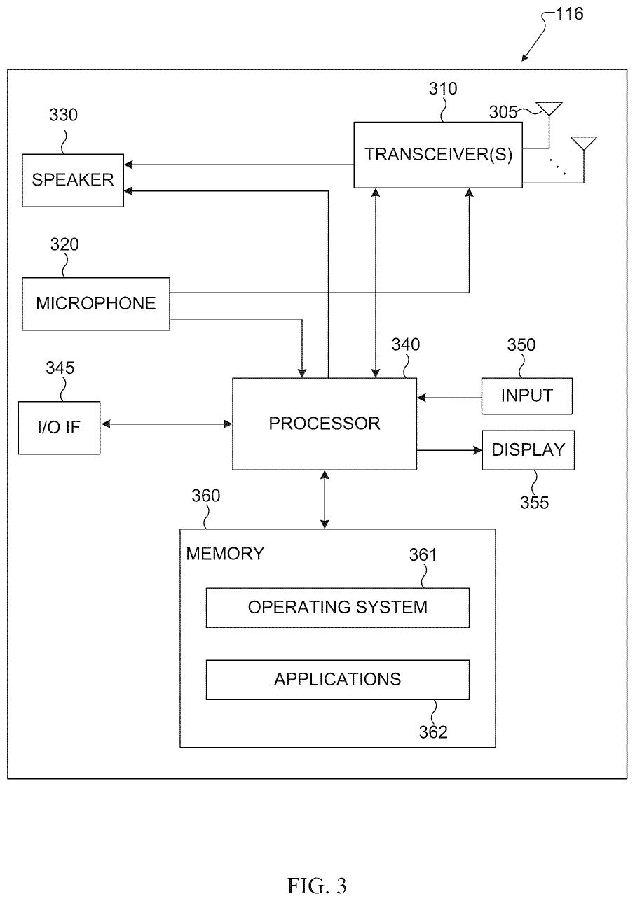

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for transmitting power reports as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

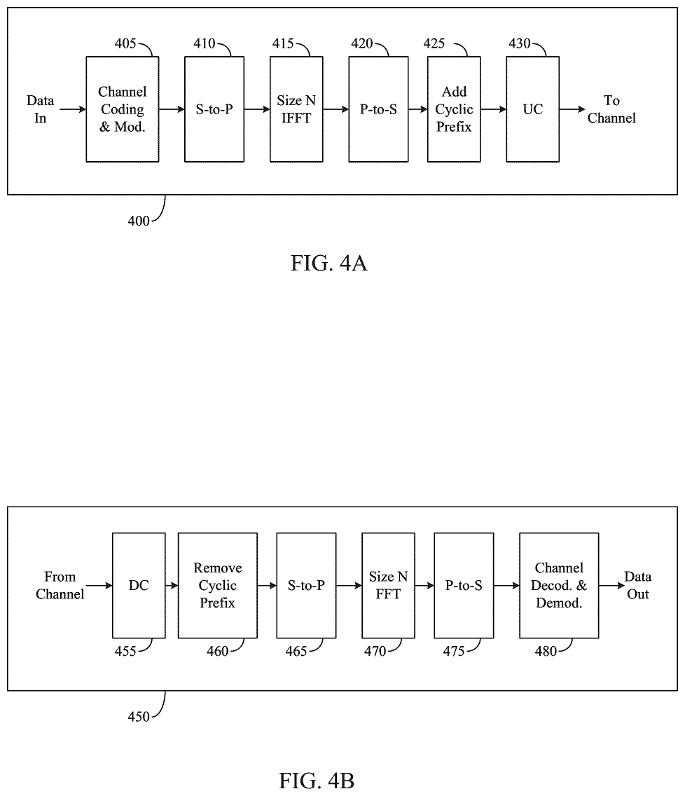

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to support transmission of power reports as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

The present disclosure relates to determining a transmit power over a time interval based on UE capabilities associated with the UE maximum output power and maximum duty cycle. The present disclosure also relates to reporting an information of a power level that the UE can use over a time period. The present disclosure further relates to a signaling associated with a report by the UE. The present disclosure also relates to triggering the report by the gNB. Throughout the disclosure, a UE power class is also referred as a UE power level. The terms power class and power level are used interchangeably in this disclosure to refer to the transmit power that the UE determines to use based on its transmit power capabilities.

A power headroom report (PHR) provides support to a gNB for power control of uplink transmissions. There are three types of PHRs: a first one for physical uplink shared channel (PUSCH) transmission, a second one for PUSCH and physical uplink control channel (PUCCH) transmission in an LTE Cell Group in EN-DC (in TS 37.340), and a third one for SRS transmission on secondary cells (SCells) configured with SRS only. Specifically:
Type 1 power headroom is the difference between the nominal UE maximum transmit power and the estimated power for uplink shared channel (UL-SCH)/PUSCH transmission per activated Serving Cell.
Type 2 power headroom is the difference between the nominal UE maximum transmit power and the estimated power for UL-SCH/PUSCH and PUCCH transmission on SpCell of the other MAC entity (i.e., evolved universal terrestrial radio access (E-UTRA) MAC entity in EN-DC, NE-DC, and NGEN-DC cases).
Type 3 power headroom is the difference between the nominal UE maximum transmit power and the estimated power for SRS transmission per activated Serving Cell.

In case of CA, when there is no transmission on an activated SCell, a reference power is used to provide a virtual PHR. To allow a network to detect a reduction in transmission power by a UE, PHR reports may also contain Power Management Maximum Power Reduction (P-MPR, in TS 38.101-2) information that the UE uses to ensure compliance with the Maximum Permissible Exposure (MPE) exposure regulation for frequency range 2 (FR2) for limiting RF exposure on human body. MPE P-MPR is defined as the power back-off to meet the MPE FR2 requirements for a Serving Cell operating on FR2.

A UE provides PHR using a MAC control element (CE). A PHR can be triggered by any of the following events:
A timer expires.
   A timer expires or has expired, and a path loss/received signal received power (RSRP) has changed more than a configured value for at least one RS used as path loss/RSRP reference for one activated Serving Cell of any MAC entity of which the active DL BWP is not dormant BWP since the last transmission of a PHR in this MAC entity when the MAC entity has UL resources for new transmission. The path loss variation for one cell assessed herein is between the path loss measured at present time on the current path loss reference and the path loss measured at the transmission time of the last transmission of PHR on the path loss reference in use at that time, irrespective of whether the path loss reference has changed in between. A UE can determine a path-loss from an RSRP measurement.
   A timer expires or has expired when the MAC entity has UL resources for new transmission. For any of the activated Serving Cells of any MAC entity with configured uplink, there are UL resources allocated for transmission or there is a PUCCH transmission on that cell. The necessary power backoff due to power management (as allowed by P-MPR_{c} as specified in TS 38.101-1, TS 38.101-2, and TS 38.101-3) for that cell has changed more than a configured value since the last transmission of a PHR when the MAC entity had UL resources allocated for transmission or PUCCH transmission on that cell.
Configuration or reconfiguration of the power headroom reporting functionality by upper layers when the PHR function is enabled.
Activation of an SCell of any MAC entity with configured uplink corresponding to a DL BWP that is not set to dormant BWP.
Activation of a secondary cell group (SCG).
Addition of the primary synchronization cell (PSCell) except if the SCG is deactivated (i.e., PSCell is newly added or changed).
Switching of activated BWP from dormant BWP to non-dormant DL BWP of an SCell of any MAC entity with configured uplink.
When MPE reporting is configured and a corresponding MPE timer is not running: the measured P-MPR applied to meet FR2 MPE requirements as specified in TS 38.101-2 is equal to or larger than a threshold for at least one activated FR2 Serving Cell since the last transmission of a PHR in this MAC entity; or the measured P-MPR applied to meet FR2 MPE requirements as specified in TS 38.101-2 has changed more than a configured value for at least one activated FR2 Serving Cell since the last transmission of a PHR due to the measured P-MPR applied to meet MPE requirements being equal to or larger than a threshold in this MAC entity. In this case the PHR is referred to as ‘MPE P-MPR report’. Triggering a PHR when the necessary power backoff due to power management decreases only temporarily (e.g., for up to a few tens of milliseconds) should be avoided so that such temporary decrease is not reflected in the values of P_{CMAX,f,c}/PH when a PHR is triggered by other triggering conditions.

A UE sets its configured maximum output power P_{CMAX,f,c} for carrier f of serving cell c in each slot between an upper limit and a lower limit as follows:

P_{CMAX_L,f,c}≤P_{CMAX,f,c}≤P_{CMAX_H,f,c} with

P_{CMAX_L,f,c}=MIN{P_{EMAX,c}−ΔT_{C,c},(P_{PowerClass}−ΔP_{PowerClass})−MAX(MAX(MPR_{c}+ΔMPR_{c},A-MPR_{c})+ΔT_{IB,c}+ΔT_{C,c}+ΔT_{RxSRS},P-MPR_{c})}, and

P_{CMAX_H,f,c}=MIN{P_{EMAX,c},P_{PowerClass}−ΔP_{PowerClass}},
where P_{EMAX,c} is provided by higher layer parameters and depends on UE capability of using power boosting with a modulation, for example Pi/2 BPSK modulation, in certain bands for a number of slots of a radio frame. P_{PowerClass} is the maximum UE power specified per power class without taking into account tolerances defined per band or band combinations. In one example, ΔP_{PowerClass} indicates a value (3 dB or 0 dB) depending on a UE capability of supporting a maximum duty cycle defined for the UE larger power class, if present, and on a percentage of uplink symbols transmitted in a certain evaluation period being larger than 25% or 50%. The maximum duty cycle is indicated for a UE power class and indicates the maximum percentage of uplink symbols that can be transmitted in a certain evaluation period using the indicated power class in order to meet SAR requirements. The maximum duty cycle can be indicated for PC2 [maxUplinkDutyCycle-PC2-FR1] or for PC1.5 [maxUplinkDutyCycle-PC1dot5-MPE-FR1]. Additional power tolerances can be provided by ΔT_{IB,c}+ΔT_{C,c}+ΔT_{RxSRS} which are related to operation with CA, supplementary uplink (SUL) or DC, in certain band or band combination, or to SRS transmission. For the UE capability of supporting a maximum duty cycle, the UE indicates a maximum percentage of uplink symbols transmitted in a certain evaluation period using the transmit power of the UE power class to meet specific absorption requirements (SAR) requirements.

MPR_{c} and A-MPR_{c} for serving cell c are related to a UE reducing a maximum output power due to higher order modulation and transmit bandwidth configurations or due to additional emission requirements signaled by the network 130, respectively. In one example, an additional emission requirement is associated with a unique network signaling (NS) value indicated in radio resource control (RRC) signaling by an NR frequency band number of the applicable operating band and by an associated value in corresponding RRC information elements. To meet the additional requirements, additional maximum power reduction (A-MPR) is allowed for the maximum output power and, unless specified otherwise, the total reduction to UE maximum output power is the maximum of MPR and A-MPR, i.e., max (MPR, A-MPR).

MPR values are specified based on the resource block (RB) allocation.

For example, there is a set of MPR values for SRS, PUCCH formats 0, 1, 3 and 4, and physical random-access channel (PRACH) are specified for QPSK modulated DFT-s-OFDM of equivalent RB allocation, and another set of MPR values for PUCCH format 2 are specified for QPSK modulated cyclic prefix (CP)-OFDM of equivalent RB allocation. For RB allocations, N_{RB} is the maximum number of RBs for a given channel bandwidth and sub-carrier spacing, where max ( ) indicates the largest value of all arguments and floor(x) is the greatest integer that is smaller than or equal to x, RB_{Start,Low}=max(1, floor(L_{CRB}/2)), and RB_{Start,High}=N_{RB}−RB_{Start,Low}−L_{CRB}. The RB allocation is an Inner RB allocation if the following conditions are met: RB_{Start,Low}≤RB_{Start}≤RB_{Start,High}, and L_{CRB}≤ceil(N_{RB}/2) where ceil(x) is the smallest integer that is larger than or equal to x. For pi/2 BPSK modulation, an RB allocation is an Edge RB allocation if RB(s) is (are) allocated at the lowermost or uppermost edge of the channel and L_{CRB}≤2 RBs. The RB allocation is an Outer RB allocation for all other allocations that are not an Inner RB allocation or, when applicable, Edge RB allocation. An RB allocation is regarded as almost contiguous allocation if CP-OFDM allocation satisfies the following conditions: N_{RB_gap}/(N_{RB_alloc}+N_{RB_gap})≤0.25 and N_{RB_alloc}+N_{RB_gap} is larger than 106, 51 or 24 RBs for 15 kHz, 30 kHz or 60 kHz SCS respectively where N_{RB_gap} is the total number of unallocated RBs between allocated RBs and N_{RB_alloc} is the total number of allocated RBs. The size and location of allocated and unallocated RBs are restricted by resource block group (RBG) parameters specified in clause 6.1.2.2 of TS 38.214 v17.3.0. For these almost contiguous signals in power class 2 and 3, the specified MPR values are increased by CELL {10 log₁₀(1+N_{RB_gap}/N_{RB_alloc}), 0.5} dB, where CEIL{x,0.5} means x rounding upwards to closest 0.5 dB. The parameters of RB_{Start,Low} and RB_{Start,High} to specify valid RB allocation ranges for Outer and Inner RB allocations are defined as RB_{Start,Low}=max(1, floor((N_{RB_alloc}+N_{RB_gap})/2)) and RB_{Start,High}=N_{RB}−RB_{Start,Low}−N_{RB_alloc}−N_{RB_gap}.

P-MPR_{c} is the power management maximum power reduction used for a UE to fulfill the SAR requirements. For example, for ensuring compliance with applicable electromagnetic energy absorption requirements and addressing unwanted emissions, self-defense requirements in case of simultaneous transmissions on multiple RATs or ensuring compliance with applicable electromagnetic energy absorption requirements in case of proximity detection is used to address such requirements that call for a lower maximum output power. It is applied for serving cell c for the cases herein. For UE conducted conformance testing P-MPR_{c} is set to 0 dB. The scope of introducing P-MPR_{c} in the P_{CMAX,f,c} equation is for the UE to report to the gNB information for an available maximum output transmit power. That information can be used by the gNB for scheduling decisions. Thus, P-A/PRc may impact the uplink performance/throughput for a UE.

A UE can indicate a capability to transmit at a maximum output power that is larger than what the power class for an UL CA/DC configuration allows for single carrier operation. For example, for the UE supporting PC3 (23 dBm) in one band (time division duplexing (TDD) or frequency division duplexing (FDD)) and PC2 (26 dBm) in another band (TDD), the CA configuration can set the maximum transmit power limit according to PC2 (26 dBm) and the maximum composite power from both transmitters would be limited to 26 dBm. With the increased maximum output power capability, the UE is allowed to transmit with the power combined over the two carriers when simultaneously transmitting at maximum power on each carrier. In this example, the maximum allowed power would be the aggregated value of 27.8 dBm. The UE capability is referred to as HigherPowerLimitCADC capability.

In one example, for uplink intra-band CA, the UE sets its configured maximum output power P_{CMAX,c} for serving cell c and its total configured maximum output power P_{CMAX}. The configured maximum output power P_{CMAX,c} on serving cell c is defined herein by setting MPR_{c}=MPR and A-MPR_{c}=A-MPR with MPR and A-MPR determined for uplink CA operation. Regarding PHR, the following exception applies: if the UE is configured with multiple uplink serving cells, the power P_{CMAX,c} used for the purpose of PH reporting on first serving cell c=c₁ does not evaluate for computation of the PH report transmissions on a second serving cell c₂ as exempted in subclause 7.7.1 in TS 38.213 v17.3.0. There is one power management term for the UE, denoted P-MPR, and P-MPR_{c}=P-MPR. A UE sets its total configured maximum output power P_{CMAX} within upper and lower bounds as P_{CMAX_L}≤P_{CMAX}≤P_{CMAX_H}. For uplink intra-band contiguous CA when same slot pattern is used in all aggregated serving cells,

P_{CMAX_L}=MIN{10 log₁₀Σp_{EMAX,c}−ΔT_{C},P_{EMAX,CA},(P_{PowerClass,CA}−ΔP_{PowerClass,CA})−MAX(MAX(MPR,A-MPR)+ΔT_{IB,c}+ΔT_{C}+ΔT_{RxSRS},P-MPR_{c})}, and

P_{CMAX_H}=MIN{10 log₁₀Σp_{EMAX,c},P_{EMAX,CA},P_{PowerClass,CA}−ΔP_{PowerClass,CA}}.

In one example, for uplink inter-band CA, the UE sets its configured maximum output power P_{CMAX,c} for serving cell c and its total configured maximum output power P_{CMAX}. The configured maximum output power P_{CMAX,c} on serving cell c is defined herein, except that the UE power class for serving cell c on the specific operating band is determined by the RRC parameter powerClassPerBand as indicated for the band combination, if signalled. For uplink inter-band carrier aggregation, MPR_{c} and A-MPR_{c} apply per serving cell c. P-MPR_{c} accounts for power management for serving cell c. The UE calculates P_{CMAX,c} under the assumption that the transmit power is increased independently on all component carriers. The UE sets its total configured maximum output power P_{CMAX} within upper and lower bounds as P_{CMAX_L}≤P_{CMAX}≤P_{CMAX_H}. For uplink inter-band CA with one serving cell c per operating band and when a same slot symbol pattern is used in all aggregated serving cells,

P_{CMAX_L}=MIN{10 log₁₀ΣMIN[p_{EMAX,c}/(Δt_{C,c}),p_{PowerClass.c}/(MAX(mpr_{c}·Δmpr_{c},a-mpr_{c})·Δt_{C,c}·Δt_{IB,c}·Δt_{RxSRS,c}),P_{PowerClass,c}/pmpr_{c}],P_{EMAX,CA},P_{PowerClass,CA}−ΔP_{PowerClass,CA}}, and

P_{CMAX_H}=MIN{10 log₁₀Σp_{EMAX,c},P_{EMAX,CA},P_{PowerClass,CA}−ΔP_{PowerClass,CA}}.

When a UE indicates a HigherPowerLimitCADC capability for a CA configuration and ΔP_{PowerClass, CA}=0, the maximum UE power as specified for the UE power class P_{PowerClass,CA} for the calculation of both P_{CMAX_L} and P_{CMAX_H} can be replaced by the sum of the UE power on each carrier as 10 log₁₀ Σ P_{PowerClass,c}. If instead the UE indicates ΔP_{PowerClass, CA}≠0, the indicated value is used in the above formulas for the calculation of P_{CMAX_L} and P_{CMAX_H}.

The maximum duty cycle is indicated for a UE power class and indicates the maximum percentage of uplink symbols that can be transmitted in a certain evaluation period using the indicated power class in order to meet SAR requirements.

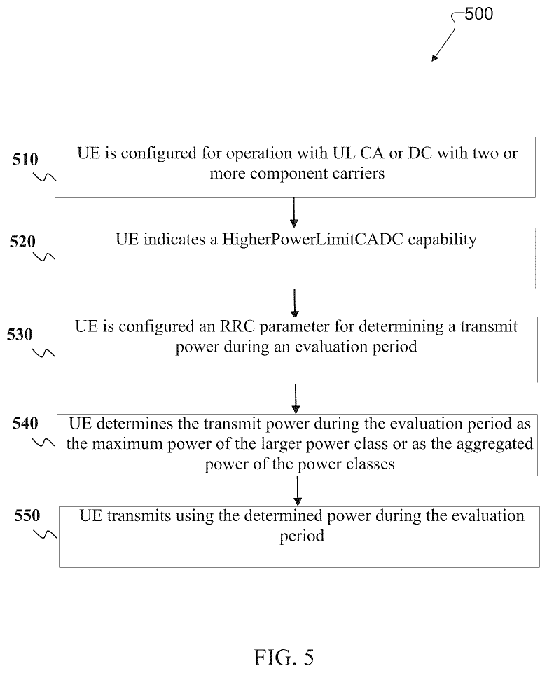

FIG. 5 illustrates a flowchart of an example procedure 500 for a UE to determine a transmit power during an evaluation period according to embodiments of the present disclosure. For example, procedure 500 for a UE to determine a transmit power during an evaluation period can be performed by any of the UEs 111-116 of FIG. 1. This example is for illustration only and other embodiments can be used without departing from the scope of the present disclosure.

The procedure begins in 510, a UE is configured for operation with UL CA or DC with two or more component carriers. In 520, the UE then indicates a HigherPowerLimitCADC capability. In 530, the UE is configured an RRC parameter for determining a transmit power during an evaluation period. In 540, the UE then determines the transmit power during the evaluation period as the maximum power of the larger power class or as the aggregated power of the two power classes. In 550, the UE then transmits using the determined power during the evaluation period. After the evaluation period, the UE can determine to operate with a same or different power class or level than the one used during the evaluation period, and accordingly report a corresponding power information in a PHR and transmit with a corresponding power.

When the UE indicates the HigherPowerLimitCADC capability and also indicates a maximum duty cycle capability, the maximum duty cycle determines the maximum average percentage of uplink symbols in a certain evaluation period that the UE can transmit over using the higher UE power class.

For example, if the UE is configured with UE PC2 and UE PC3 for the two carriers then, based on the maximum duty cycle, the UE determines whether to operate at UE PC2 or UE PC3, with PC3 being the default power class. As for single carrier operation, the maximum duty cycle that is indicated for a UE power class and for CA can indicate the maximum average percentage of uplink symbols that the UE can use to transmit in a certain evaluation period using the larger power class in order to meet SAR requirements.

In the example of CA with PC2 and PC3, the UE indicates the capability of the maximum duty cycle when transmitting at PC2 that is the higher power class. It is also possible that the UE determines the maximum average percentage of uplink symbols that the UE can use to transmit in a certain evaluation period by assuming that the UE transmits with the aggregated transmit power when the UE has also indicated the HigherPowerLimitCADC capability, and that the UE indicates the maximum duty cycle for the case that the UE transmits with the aggregated power of the two UE power classes. In this case the SAR requirements are met assuming that the UE transmits with the aggregated power. Whether the UE transmit power is assumed to be the power corresponding to the higher power class or the aggregated power of the two UE power classes during the evaluation period for SAR requirements, can be determined based on an RRC parameter provided by a serving gNB. Based on such configuration, the UE provides the maximum duty cycle for operating with the larger UE power class, for operating with the aggregated power, or for both. Then the gNB can determine the uplink scheduling for the UE based on the maximum duty cycle for operating with the larger UE power class and the maximum duty cycle for operating with the aggregated power. In case of more than two carriers, and in case the UE has the capability of transmitting with an aggregated power from more than two carriers the UE can indicate the maximum duty cycle assuming the aggregated transmit power over the multiple carriers and also indicate the maximum duty cycle for the larger UE power class.

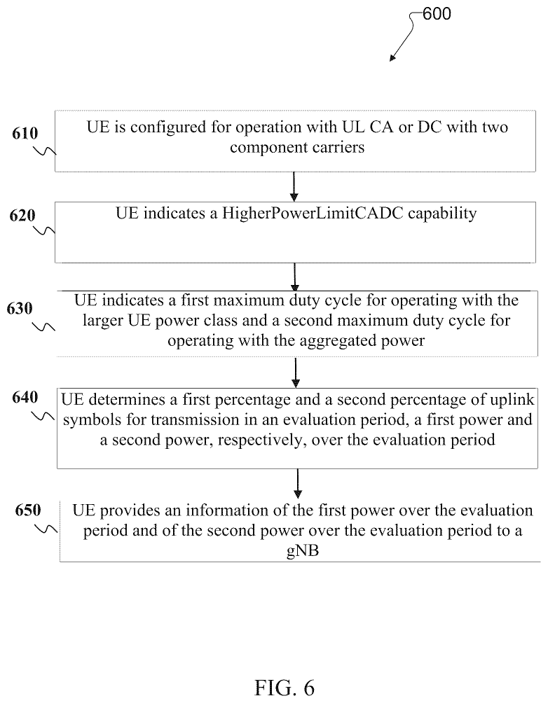

FIG. 6 illustrates a flowchart of another example procedure 600 for a UE to determine a transmit power during an evaluation period according to embodiments of the present disclosure. For example, procedure 600 for a UE to determine a transmit power during an evaluation period can be performed by the UE 116 of FIG. 3. This example is for illustration only and other embodiments can be used without departing from the scope of the present disclosure.

The procedure begins in 610, a UE is configured for operation with UL CA or DC with two component carriers. In 620, the UE then indicates a HigherPowerLimitCADC capability. In 630, the UE indicates a first maximum duty cycle for operating with the larger UE power class and a second maximum duty cycle for operating with the aggregated power. In 640, the UE then determines a first percentage and a second percentage of uplink symbols for transmission in an evaluation period, a first power and a second power, respectively, over the evaluation period. In 650, the UE provides an information of the first power over the evaluation period and of the second power over the evaluation period to a gNB.

In order to enhance UL scheduling, a UE can provide more information to a gNB about its capability of transmitting with a certain power over a certain period of time. The UE provides the PHR that indicates the amount of transmit power available for the UE to use in addition to the power being used by the current transmission and according to a used power class. Useful information for the gNB can be the knowledge of the UE power available over a certain time period. That is equivalent to an energy the UE can use over the time period.

For example, the UE can report how much power the UE has available for a time period or for a number of time periods. The time periods may or may not overlap.

For example, the UE can report how much power the UE has available over the next 10 msec, 20 msec, 40 msec, or 80 msec.

Alternatively, the UE can report how much power the UE has available for next 4, 8, 16, or 32 PUSCH transmissions over a reference number of symbols for each PUSCH transmission wherein the reference number of symbols can be defined in the specifications of the system operation or by indicated by a serving gNB by higher layer signaling, such as RRC or MAC CE, and can be with respect to a reference sub-carrier spacing (SCS) or with respect to a SCS for the active BWP of the PUSCH transmissions.

For operation with single carrier, the UE measures the transmit power over a time interval while satisfying the SAR requirements and estimates the amount of power that the UE has available over a next time period. Then, the UE provides the information to the network 130, indicating both the available power over a time period and the time period. The UE can also indicate multiple values for an available power over multiple time periods, for example, based on a configuration by the serving gNB for corresponding reports. This information is an energy report from the UE to the gNB.

For operation with multiple UL carriers, the UE can provide an energy report per UL carrier or for a number of aggregated carriers. If the UE operates with two UL carriers, the energy report can be for each carrier separately or for both carriers. When the UE operates with CA with two UL carriers, the energy report is determined for the CA configuration, and if the UE indicates a HigherPowerLimitCADC capability for that CA configuration, the UE can determine the energy report assuming that the UE transmits with the aggregated power according to the HigherPowerLimitCADC capability. It is possible that the UE determines the energy report assuming that the UE transmits with a power determined by the larger UE power class among the configured power class for each component carrier. Whether the UE transmits with the aggregate power or with the power of the larger power class, it can be indicated by RRC, by a MAC CE, or by a combination of an RRC parameter and a MAC CE indication by the serving gNB. It is also possible that the UE conveys that information when providing the corresponding energy report.

When the UE operates with more than two UL carriers, for example, with four carriers, and one or two or four carriers can be used by the UE for simultaneous transmissions, the UE can provide energy reports for operation with one, two and four carriers, and for different pairs of UL carriers.

In another example, if the UE can operate with eight carriers, the energy report can be for operation with one carrier, two, four, and eight carriers, and for different combinations of two and four carriers.

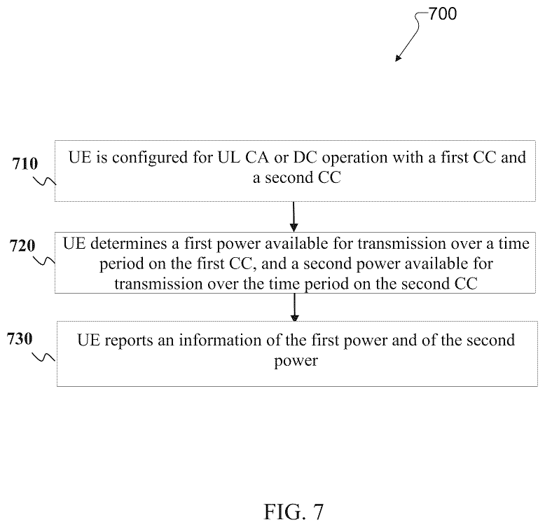

FIG. 7 illustrates a flowchart of an example procedure 700 for a UE to report an available power over a time period for UL, CA, or DC operation with a first and second CC according to embodiments of the present disclosure. For example, procedure 700 for a UE to report an available power over a time period for UL, CA, or DC operation with a first and second CC can be performed by any of UEs 111-116 of FIG. 1. This example is for illustration only and other embodiments can be used without departing from the scope of the present disclosure.

The procedure begins in 710, a UE is configured for UL CA or DC operation with a first CC and a second CC. In 720, the UE then determines a first power available for transmission over a time period on the first CC, and a second power available for transmission over the time period on the second CC. In 730, the UE reports an information of the first power and of the second power.

For operation with multiple UL BWPs, the UE can provide an energy report per UL BWP. If the UE is configured with multiple UL BWP on respective cells and all UL BWPs are active, the UE can report the energy information for each of the active BWPs. If the UE is configured with multiple UL BWP on respective cells and not all UL BWPs are active, the UE can report the energy information for each of the active and non-active BWPs, or for some of the active and some of the non-active BWPs. If a BWP is active and the UE is not scheduled to transmit on that BWP, the UE can report the energy information for that BWP. Depending on whether the UL BWP is active or non-active, or for an active UL BWP on whether or not the UE is scheduled to transmit on the active UL BWP, the energy report can be triggered by the gNB, or the UE can provide the energy report without an explicit trigger by the network 130.

A UE can provide an energy report for portions of an UL BWP. For example, if the UE can operate with the UL BWP, or with one or more sub-bands of the UL BWP, the UE can report the energy information for the UL BWP or for the one or more sub-bands of the UL BWP.

A UE can provide an energy report for portions of a DL BWP. For example, if the UE can operate in the UL for one or more sub-bands of the DL BWP, the UE can report the energy information for the one or more sub-bands.

A UE can provide an energy report for a BWP that can be used for UL or DL, or portions of the BWP that can be used for UL. For example, if the UE operates with a BWP as DL, the UE can provide the energy report corresponding to UL operation in the whole BWP or in sub-bands of the BWP.

For a UE capable of operating with multiple transmitters, such as multiple antenna panels or for different RATs, the UE can provide multiple energy reports associated to UE transmission with some or all of the multiple transmitters. The energy report can be also associated to UE transmission with a number of MIMO layers, with one or multiple beams, and to a single TRP or to multiple TRPs.

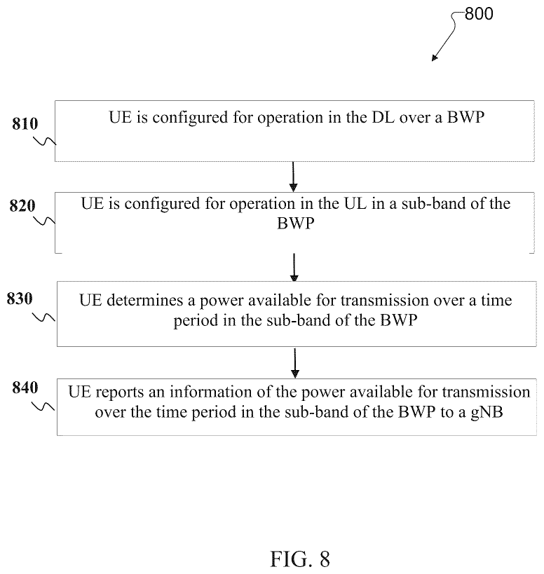

FIG. 8 illustrates a flowchart of an example procedure 800 for a UE to report an available power for transmission over a time period for a subband of a DL BWP according to embodiments of the present disclosure. For example, procedure 800 for a UE to report an available power for transmission over a time period for a subband of a DL BWP can be performed by the UE 116 of FIG. 3. This example is for illustration only and other embodiments can be used without departing from the scope of the present disclosure.

The procedure begins in 810, a UE is configured for operation in the DL over a BWP. In 820, the UE then is configured for operation in the UL in a sub-band of the BWP. In 830, the UE then determines a power available for transmission over a time period in the sub-band of the BWP. In 840, the UE then reports an information of the power available for transmission over the time period in the sub-band of the BWP to a gNB.

A UE can report energy information to a gNB related to a time interval T, with T being the time interval over which the UE can transmit with a certain maximum power. The time interval T is the transmission time interval. The gNB can configure by RRC different states corresponding to different energy levels between a maximum energy state and a minimum energy state. The minimum energy state can be associated with the UE being capable of transmitting with the same energy used in the measurement window, over the transmission time interval associated with the minimum energy state, or with the UE being capable of transmitting with a minimum energy level which can be a configured or fixed value, over the associate transmission time interval, or with the UE not being capable of transmitting over the associated transmission time interval. The gNB can configure multiple energy states, for examples 4 states, each corresponding to an energy level. The energy states can be associated with a transmission time interval, which is the interval over which the UE is capable of transmitting with a power corresponding to the energy state, or each energy state can be associated with a transmission time interval from a set of transmission time intervals.

For example, energy states 1 to 4 are associated with a transmission time interval of 10 ms or are associated with transmission time intervals of {10, 20, 40, 80} msec, respectively. It is also possible that different energy states are associated with different sets.

For example, the gNB configures 2 energy states corresponding to 2 energy levels, and the larger energy state can be associated with a set of 4 values, for example {10, 20, 40, 80}, and the smaller energy states can be associated with a set of 4 values, for example {40, 80, 160, 320} ms, or with set of 2 values {120, 240} ms. The transmission time interval can be in units of msec, frames, or it can be in units of slots or symbols of a reference or indicated SCS.

A gNB can configure energy states and transmission time intervals to the UE by RRC signaling. For example, the gNB configures four energy states and also configures four transmission time intervals. The UE can indicate one of the four states using a 2-bit signaling with, for example, ‘00’ indicating the larger energy state and ‘11’ indicating the smaller energy state, or vice versa. If the four states are associated to the four transmission time intervals with a 1-to-1 mapping, the indication of the energy state is sufficient. When each of the four states can be associated with any of the four values of the transmission time interval, the UE can additionally use a 2-bit signaling to indicate the time interval. It is also possible that the energy states and the transmission time intervals can be jointly indicated.

For example, certain energy states can only be associated with certain transmission time interval, and there can be a number of possible combinations of energy levels and transmission time intervals.

For example, the number of combinations can be 8 or 16, and the UE uses 3 or 4 bits to indicate one of the combinations. The indication by the UE can be by MAC CE or by uplink control information (UCI) in a PUCCH or PUSCH.

Energy levels and transmission time intervals can be subject to one or more UE capabilities. Based on the UE capabilities and other configurations, a gNB can indicate to the UE a set of energy levels and a set of transmission time intervals. The energy levels and the transmission time intervals can also be impacted by changes in operating conditions that are not due to a change in a configuration. To avoid a delay associated with a reconfiguration of energy levels and transmission time intervals, the gNB can indicate by MAC CE or by DCI format more than one set of energy levels and more than one transmission time interval or more than one set of transmission time intervals, and indicate a set of energy levels or transmission time intervals, or set of transmission time intervals, for the UE to use.

An energy report can be associated to a UE capability. A UE can indicate its capability for supporting the energy report. The capability can be further associated to a granularity of the energy level to a minimum and a maximum energy level, and to a time interval that represents a maximum time interval for the validity of the energy report. The validity time interval can start at the end of the measurement time window or start after an additional time interval after the end of the measurement window.

A transmission time interval can be determined based also on a periodicity P. A UE can be provided a periodicity P in units of msec or frames, or in unit of slots or symbols of an indicated or reference SCS, and a set of transmission time intervals by one or more RRC parameters.

In a first example a UE is provided a periodicity P and a set of transmission time intervals {10, 20, 40, 80} msec. A UE can receive an indication by a MAC CE or by a DCI format for a transmission time interval from the set that is valid for a period P. In subsequent periods, the transmission time interval is determined by cycling over values of the configured set. It is possible that the UE receives a MAC CE activation command and in a first period P after activation the value is 10 msec, in a subsequent period P the value is 20 msec, and so on. When a UE does not receive an indication, a default value for the transmission time interval can be the first value of the configured/indicated set, a default value can be separately indicated, or can be a defined value in the specifications.

In a second example, a transmission time interval can change in a subsequent period P if a UE receives an indication by a MAC CE or by a DCI format for a different transmission time interval. In absence of an indication, the transmission time interval in the subsequent period remains same as in the previous period P.

For example, a UE is indicated a first value from the configured set of values for a first period P. If the UE receives an indication for a second value, the UE applies the second value for the transmission time interval in the next period P, or after a number of periods, wherein the number of periods can be an indicated or defined value.

In a third example, a validity timer is associated with each transmission time interval. The validity timer can be a multiple of a periodicity P. For example, a UE is indicated a transmission time interval of 20 msec and a validity time of D×P where D>=1. During the validity timer, the transmission time interval remains the same and the UE does not expect to receive an indication of a transmission time interval. After the validity timer ends/expires, the transmission time interval changes when the UE receives an indication for another transmission time interval or when a configuration indicates that after the validity timer ends/expires the transmission time changes, for example by cycling over two values or over four values. The UE can determine the measurement time interval based on regulatory requirements and may not indicate the measurement time interval to the gNB. The UE may also use the duration of the transmission time interval to determine the measurement time interval. To avoid frequent changes to the measurement time interval, although the determination of the measurement period may not be impacted by the indication of the transmission time interval by the gNB, the change of the transmission time interval can be allowed only with a certain periodicity P or after a validity period expires.

A UE can be indicated a number of energy states and a transmission time interval from a set of transmission time intervals. The transmission time intervals in the set may or may not overlap.

In a first example, the transmission time intervals overlap can start at a same time instant and have different durations or can start at staggered time instants and have same or different durations. For example, the transmission time intervals can be {T, 2T, 4T, 8T} with a same start time instant to, or with start times {t0, t0+δ1, t0+δ2, t0+δ3}.

In a second example, the transmission time intervals do not overlap, and the duration of each transmission time interval can be the same or different. The starting time of each time interval is after the end of a previous time interval.

The start time of the transmission time interval can be after a time interval A from the end of the measurement window. The value of A can be indicated and can be in units of msec or frames, in units of slots or symbols for a reference or indicated SCS, or can be a defined value in the specifications. The value of A can also be subject to a UE capability. The gNB can indicate by an RRC parameter multiple values for the time interval A and the UE can indicate by a MAC CE, by UCI in a PUCCH or PUSCH, or one of the configured values.

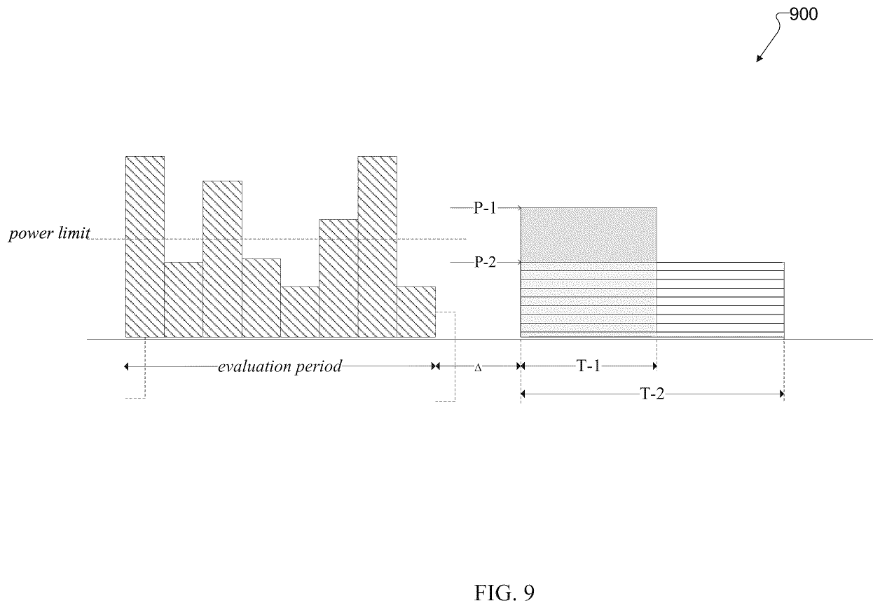

FIG. 9 illustrates an example of a timeline 900 for a UE to estimate an average power and support a corresponding power level according to embodiments of the present disclosure. For example, timeline 900 for a UE to estimate an average power and support a corresponding power level can be utilized by the UE 116 of FIG. 3. This example is for illustration only and can be used without departing from the scope of the present disclosure.

Presented is a timeline of an evaluation period over which the UE estimates an average transmit power subject to limitation from regulations and a time interval A between the end of the evaluation period and the start of a transmission time interval over which the UE can support a corresponding power level, with power level P-1 associated to the interval T-1 and power level P-2 associated with the interval T-2.

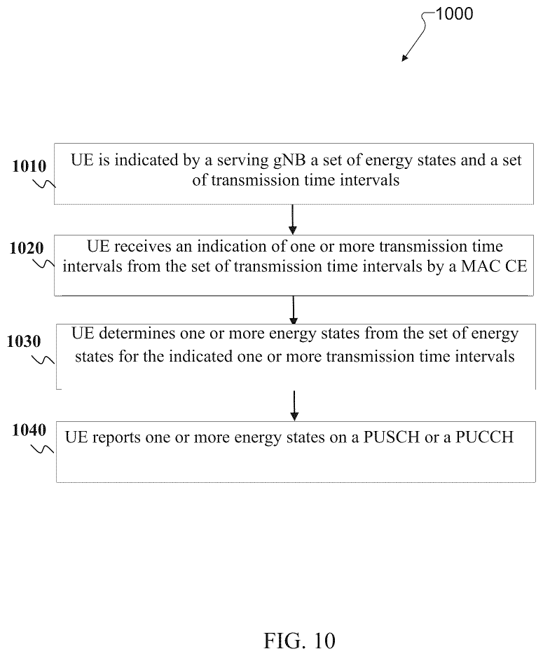

FIG. 10 illustrates a flowchart of an example procedure 1000 for a UE to determine an energy report associated with an indicated transmission time interval based on an indication by a higher layer or by a DCI format according to embodiments of the present disclosure. For example, procedure 1000 can be performed by the UE 116 of FIG. 3.

The procedure begins in 1010, a UE is indicated by a serving gNB a set of energy states and a set of transmission time intervals, for example by RRC signaling. In 1020, the UE then receives an indication of one or more transmission time intervals from the set of transmission time intervals by a MAC CE. Alternatively, in step 1020 the indication is by a DCI format. In 1030, the UE then determines one or more energy states from the set of energy states for the indicated one or more transmission time intervals. In 1040, the UE reports one or more energy states on a PUSCH or a PUCCH.

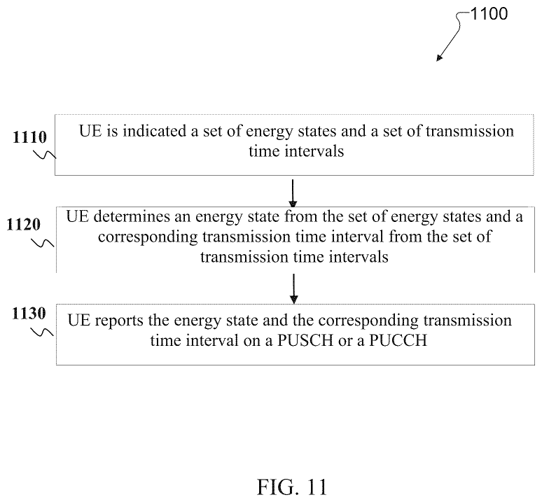

FIG. 11 illustrates a flowchart of an example procedure 1100 for a UE to determine an energy report associated with a transmission time interval determined by the UE according to embodiments of the present disclosure. For example, procedure 1100 for a UE to determine an energy report associated with a transmission time interval determined by the UE can be performed by any of the UEs 111-166 of FIG. 1. This example is for illustration only and other embodiments can be used without departing from the scope of the present disclosure.

The procedure begins in 1110, a UE is indicated a set of energy states and a set of transmission time intervals, for example by RRC signaling. In 1120, the UE then determines an energy state from the set of energy states and a corresponding transmission time interval from the set of transmission time intervals. In 1130, the UE then reports the energy state and the corresponding transmission time interval on a PUSCH or PUCCH.

A gNB can request or trigger an energy report from a UE by an indication in a MAC CE or in a DCI format. The UE can receive the request or trigger with a certain periodicity Pimp which is the minimum time interval between two consecutive requests. The UE may not receive a request in each period. If the request is by a DCI format, the UE expects to monitor a physical downlink control channel (PDCCH) with the DCI format that includes the energy report request with periodicity Pimp.

Alternatively, or additionally, the energy report request can be provided by a DCI format scheduling an UL transmission such as for a PUSCH.

The energy report request can include information on a transmission time interval that is the time interval over which the energy report from the UE is valid. The request may additionally include information related to cell/carrier/BWP for which the UE would provide one or more energy reports, such as:
one or more uplink carriers of a serving or a non-serving cell, one or more UL BWPs, wherein some of the UL BWPs are active and some are non-active, or all UL BWPs are active,
one or more sub-bands of a DL BWP when the UE is configured with operation in half-duplex mode or full-duplex mode and one or more sub-bands of the DL BWP can be used as UL sub-bands, and/or
one or more sub-band of an UL BWP. The UE can be configured with operation with a smaller bandwidth than the configured UL BWP (for example a RedCap UE) or with operation in multiple sub-bands of the UL BWP.

A UE can receive a request to provide multiple energy reports for one or more transmission time intervals, and/or one or more UL carriers, and/or one or more CA configurations, wherein the UE may indicate a HigherPowerLimitCADC capability for the one or more CA configurations, and/or one or more UL BWPs, and/or one or more configurations of aggregation of UL BWPs, and/or one or more sub-bands of a DL BWP or of an UL BWP. It is also possible that the energy report request is for a transmission scheme configuration, for example, for UE operation with a certain number of MIMO layers or with a certain number of transmit antennas, such as with single antenna and maximum number of antennas.

A UE can receive a request to provide one or more energy reports by a MAC CE. The MAC CE can include the energy report request and additionally include indications for a transmission time interval, carrier, BWP, or sub-band that are indicated by RRC.

It is possible that the request for an energy report is by a DCI format and other indications related to the energy report are by a MAC CE. The UE can receive a PDCCH that provides the DCI format with an energy report request field. The DCI field can be a 1-bit field, with value “1” indicating the request for the energy report and value “0” indicating no request, or vice versa.

It is also possible that a 2-bit DCI field indicates one of three energy report request configurations, wherein each configuration includes one or more parameters, where a value “00” indicates no request for an energy report. A parameter can indicate one or more transmission time intervals, one or more carriers, one or more BWPs, or one or more sub-bands of an UL BWP, or one or more sub-bands of a DL BWP. The energy report request configurations can be provided by a serving gNB by RRC signaling.

A UE can receive a request to provide one or more energy reports by a DCI format, wherein fields of the DCI format indicate a configured value for one or more RRC parameters. The DCI format can include one or more of the following fields:
energy report request field of 1 bit.
transmission time interval field of 2 bits.
UL carrier indication field is a bitmap with size equal to the number of UL carriers: a value ‘1’ for a bit of the bitmap indicates request of the energy report, a value ‘0’ for a bit of the bitmap indicates no request of the energy report, or vice versa.
UL BWP indication field is a bitmap with size equal to the number of UL BWP: a value ‘1’ for a bit of the bitmap indicates request of the energy report, a value ‘0’ for a bit of the bitmap, or vice versa.
sub-bands indication field is a bitmap with size equal to the number of sub-bands of a BWP: a value ‘1’ for a bit of the bitmap indicates request of the energy report, a value ‘0’ for a bit of the bitmap, or vice versa.

Upon reception of an indication to provide an energy report, the UE provides the energy report on a PUSCH or a PUCCH that may be scheduled by a same DCI format that includes the energy report request of by a different DCI format.

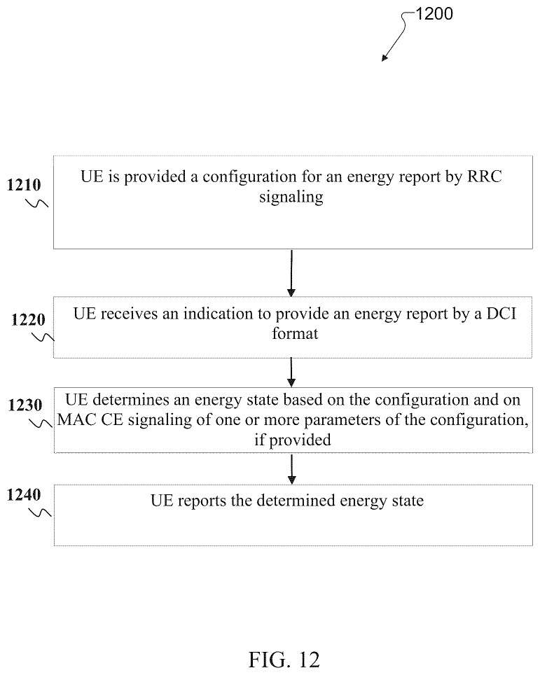

FIG. 12 illustrates a flowchart of an example procedure 1200 for a UE to provide an energy report based on a triggering by a gNB according to embodiments of the present disclosure. For example, procedure 1200 for a UE to provide an energy report based on a triggering by a gNB can be performed by the UE 116 of FIG. 3. This example is for illustration only and other embodiments can be used without departing from the scope of the present disclosure.

The procedure begins in 1210, a UE is provided a configuration for energy reports by RRC signaling, wherein the configuration includes one or more of: a set of energy states, one or more transmission time intervals, one or more UL carriers, one or more CA configurations, one or more UL BWPs, one or more configurations of aggregation of UL BWPs, one or more sub-bands of a DL BWP and/or of an UL BWP. In 1220, the UE then receives an indication to provide an energy report by a DCI format. In 1230, the UE then determines an energy state based on the configuration and on MAC CE signaling of one or more parameters of the configuration, if provided in 1030. Alternatively, in step 1230, the UE then determines an energy state based on the configuration and on DCI format signaling of one or more parameters of the configuration, if provided. In 1240, the UE then reports the determined energy state.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to transmit first information indicating a first power class associated with a first maximum output power on a first carrier; and
a processor operably coupled to the transceiver, the processor configured to determine a delta power class associated with the first power class on the first carrier, wherein the delta power class is a power offset for the first power class,
wherein the transceiver is further configured to transmit second information indicating the delta power class in a power headroom report.

2. The UE of claim 1, wherein:
the transceiver is further configured to transmit third information indicating a duty cycle; and
the processor is further configured to determine a transmission occasion for transmitting the second information based on the duty cycle.

3. The UE of claim 1, wherein:
the transceiver is further configured to transmit third information indicating a duty cycle,
the duty cycle is associated with more than one power classes on corresponding more than one carriers, and
the delta power class is further associated with the more than one power classes.

4. The UE of claim 1, wherein the transceiver is further configured to receive a physical downlink control channel (PDCCH) providing a DCI format that includes a request to report the second information.

5. The UE of claim 1, wherein the transceiver is further configured to transmit third information for a set of duty cycles associated with a set of power classes for a corresponding set of carriers.

6. The UE of claim 1, wherein:
the processor is further configured to determine:
a time period associated with a validity of the second information,
a second maximum output power based on the first maximum output power and the delta power class, and
a first power based on the first maximum output power and a second power based on the second maximum output power; and
the transceiver is further configured to transmit:
third information associated with the time period, and
an uplink physical channel using the second power during the time period.

7. The UE of claim 6, wherein the transceiver is further configured to transmit the uplink physical channel using the first power after the time period.

8. A base station (BS) comprising:
a transceiver configured to receive:
first information indicating a first power class associated with a first maximum output power on a first carrier, and
second information, in a power headroom report, indicating a delta power class, wherein the delta power class is a power offset for the first power class; and
a processor operably coupled to the transceiver, the processor configured to determine the delta power class associated with the first power class on the first carrier.

9. The BS of claim 8, wherein:
the transceiver is further configured to receive third information indicating a duty cycle; and
the processor is further configured to determine a reception occasion for receiving the second information based on the duty cycle.

10. The BS of claim 8, wherein:
the transceiver is further configured to receive third information indicating a duty cycle,
the duty cycle is associated with more than one power classes on corresponding more than one carriers, and
the delta power class is further associated with the more than one power classes.

11. The BS of claim 8, wherein the transceiver is further configured to transmit a physical downlink control channel (PDCCH) providing a DCI format that includes a request to report the second information.

12. The BS of claim 8, wherein the transceiver is further configured to receive third information for a set of duty cycles associated with a set of power classes for a corresponding set of carriers.

13. The BS of claim 8, wherein:
the transceiver is further configured to receive:
third information associated with a time period associated with a validity of the second information, and
an uplink physical channel with:
a first power based on a first maximum output power after the time period, and
a second power based on a second maximum output power during the time period.

14. A method comprising:
transmitting first information indicating a first power class associated with a first maximum output power on a first carrier;
determining a delta power class associated with the first power class on the first carrier, wherein the delta power class is a power offset for the first power class; and
transmitting second information indicating the delta power class in a power headroom report.

15. The method of claim 14, further comprising:
transmitting third information indicating a duty cycle; and
determining a transmission occasion for transmitting the second information based on the duty cycle.

16. The method of claim 14, further comprising:
transmitting third information indicating a duty cycle,
wherein the duty cycle is associated with more than one power classes on corresponding more than one carriers; and
wherein the delta power class is further associated with the more than one power classes.

17. The method of claim 14, further comprising receiving a physical downlink control channel (PDCCH) providing a DCI format that includes a request to report the second information.

18. The method of claim 14, further comprising transmitting third information for a set of duty cycles associated with a set of power classes for a corresponding set of carriers.

19. The method of claim 14, further comprising:
determining:
a time period associated with a validity of the second information,
a second maximum output power based on the first maximum output power and the delta power class, and
a first power based on the first maximum output power and a second power based on the second maximum output power; and
transmitting:
third information associated with the time period, and
an uplink physical channel using the second power during the time period.

20. The method of claim 19, further comprising transmitting the uplink physical channel using the first power after the time period.
